(19) United States
(12) Patent Application Publication
(10) Pub. No.: US 2018/0279837 A1
(43) Pub. Date: Oct. 4, 2018

(54) SCALD-PROOF POT HANDLE

(71) Applicant: Cocaba Cookware Manufacture Co., Ltd., Cixi City (CN)

(72) Inventor: En WANG, Cixi City (CN)

(21) Appl. No.: 15/656,673

(22) Filed: Jul. 21, 2017

(30) Foreign Application Priority Data
Mar. 30, 2017 (CN) 201710202628.3

(51) Int. Cl. A47J 45/08

(52) U.S. Cl. CPC A47J 45/08

(57) ABSTRACT

The present invention relates to a scald-proof pot handle, comprising a proximal end, a handle body and a distal end which are connected in order. A heat absorbing component is disposed within the handle body and extends along the same direction of the handle body. The heat absorbing component is connected and fixed to one end of the handle body, and an air layer is formed between the heat absorbing component and the handle body. The proximal end comprises a first connecting portion and a second connecting portion. The first connecting portion is connected to the pot body, and the second connecting portion is connected to the handle body. The end surface of the first connecting portion that contacts with the pot body is a curved surface, and the radian of the curved surface is consistent with the radian of the surface of the pot body. In the present invention, the contact area between the pot body and the pot handle is decreased, the area of the pot handle that is in direct contact with the fire is reduced, and a heat absorbing component is adopted within the pot handle, thereby effectively lowering the temperature and preventing the user from being scalded while the pot handle is being held.

### TECHNICAL FIELD

The present invention relates to a component of a cooking container, more specifically, to a scald-proof pot handle.

### BACKGROUND

Handles of cooking containers such as woks, pans and stockpots, which are commonly used in daily life and usually made of metal materials. During the operation such as stir-frying, frying, braise and the like, the heat would be conducted rapidly to the pot handle through the pot body since the pot handle which is made of metal materials has high heat conductivity. The normal operation and use will be adversely affected due to the feeling of very hot, especially when the pot body is heated to a high temperature or for a long time. The heat conducted to the pot handle accumulates continually and thus the temperature of the pot handle rises rapidly, so the user is apt to be scalded.

The Chinese patent publication CN 202146229 U discloses a silicone pot handle which is characterized in that: the metal pot handle, which is connected to the pot body, is covered with a silicone handle sleeve serving to prevent scalding. However, the silicone material tends to harden when exposed to a long-term high temperature and thus the metal pot handle could not be thermally isolated fundamentally through this approach.

### SUMMARY

The technical problem to be solved in the present invention is to overcome the deficiency of the prior art and provide a scald-proof pot handle with good heat isolation effect.

The technical solution for solving the above technical problem is provided as follows: a scald-proof pot handle comprises a proximal end, a handle body and a distal end which are connected in order. A heat absorbing component is disposed within the handle body and extends along the same direction as the handle body. The heat absorbing component is connected and fixed to one end of the handle body, and an air layer is formed between the heat absorbing component and the handle body.

Furthermore, the proximal end comprises a first connecting portion and a second connecting portion. The first connecting portion is connected to the pot body, the second connecting portion is connected to the handle body, and the ratio k of the minimum width of the joint between the first connecting portion and the second connecting portion to the maximum of the width of the handle body ranges from 0.1 to 0.6.

Furthermore, the end surface of the first connecting portion that contacts with the pot body is a curved surface, and the radian of the curved surface is consistent with the radian of the surface of the pot body.

Furthermore, at the edge of the end surface of the first connecting portion that contacts with the pot body, bumps protruding toward the pot body are disposed, and the portion of the bump that is in contact with the pot body is attached closely to the pot body.

Furthermore, the bumps are arranged in a circle along the edge of the end surface of the first connecting portion that is connected to the pot body.

Furthermore, the proximal end, the handle body and the distal end are all made of stainless steel.

Furthermore, the two ends of the first connecting portion are symmetrically provided with rivet holes which are used to connect the pot body and the first connecting portion.

Furthermore, the maximum width of the handle body is less than the maximum width of the first connecting portion and greater than the maximum width of the distal end.

Furthermore, the top end surface of the distal end is provided with an extending portion. The extending portion is provided with an opening for hanging the pot handle.

Furthermore, the handle body is connected to the proximal end and the distal end through being inserted into them, and the joints are fixed.

Compared with the prior art, the present invention has the following advantages: a heat absorbing component and an air layer is disposed within the handle body so as to block the heat conducted from the pot body to the pot handle, thereby lowering the temperature of the pot handle and preventing the user from being scalded while the pot handle is being held. Moreover, in the present invention, the heating area of the proximal end is further decreased and thus the heat conducted through the proximal end is reduced. Besides, this configuration of the pot handle could realize a good heat isolation effect with a sufficient overall strength.

### BRIEF DESCRIPTION OF THE DRAWINGS

FIG. 1 schematically illustrates the configuration of the scald-proof pot handle according to the present invention;

FIG. 2 is the sectional view of FIG. 1 along line A-A;

FIG. 3 is the sectional view of FIG. 1 along line B-B.

### DETAILED DESCRIPTION

In the following paragraphs, further details of the present invention are described with reference to the drawings and embodiments.

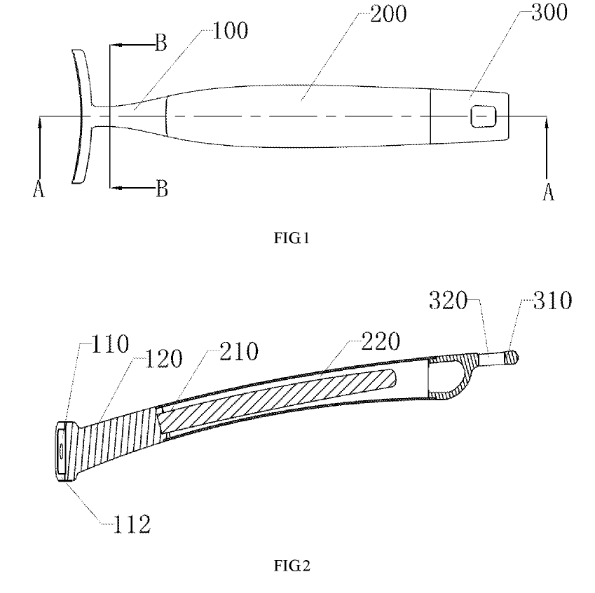

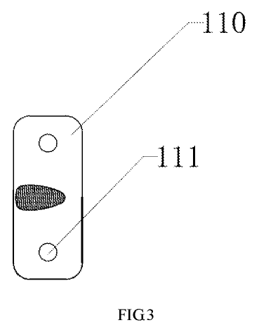

FIG. 1 to FIG. 3 illustrate a scald-proof pot handle comprising a proximal end 100, a handle body 200 and a distal end 300 which are connected in order. A heat absorbing component 210 is disposed within the handle body 200 and extends along the same direction as the handle body 200. The heat absorbing component 210 is connected and fixed to one end of the handle body 200. An air layer 220 is formed between the heat absorbing component 210 and the handle body 200. The heat absorbing component 210 may be a core made of iron or other materials with high heat conductivity. The air layer 220 may serve to block the heat transfer.

The proximal end 100 comprises a first connecting portion 110 connected to the pot body and a second connecting portion 120 connected to the handle body 200. The extension direction of the second connecting portion 120 is perpendicular to the extension direction of the first connecting portion 110, and the second connecting portion 120 is connected to the first connecting portion 110 at the center of the first connecting portion 110. In order to decrease the contact area between the proximal end and the fire from the bottom up during cooking process, it is needed to reduce the minimum width in horizontal direction of the joint between the first connecting portion 110 and the second connecting portion 120, i.e., the minimum width h of the proximal end. In the prior art, the ratio k of the minimum width h of the proximal end to the maximum horizontal width H of the handle body of the pot handle is usually greater than or equal to 0.8. For example, the minimum width h of the proximal end is 20 mm, and the maximum width of the handle body is 25 mm. In the embodiment of the present invention, the ratio k of the minimum width h of the proximal end to the maximum width of the handle body ranges from 0.1 to 0.6. For example, the minimum width h of the proximal end is 4 mm, the maximum width of the handle body is 40 mm, and the ratio of them is 0.1. For another example, the minimum width h of the proximal end is 12 mm, the maximum width of the handle body is 20 mm, and the ratio of them is 0.6. Theoretically, the smaller k is, the smaller the contact area between the proximal end and the fire is, and hence the less heat is received.

During the cooking process, the proximal end 100 needs to bear the weight of the pot body and the food. Due to the limitation to the material of the pot handle in the prior art, when the width of the joint between the first connecting portion 110 and the second connecting portion 120 is narrowed, in order to make sure the joint of the first connecting portion 110 and the second connecting portion 120 is firm enough, the vertical thickness of the joint needs to be increased appropriately. Compared with the conventional proximal end, the width of the proximal end of the present embodiment is reduced, so the area of the proximal end in contact with the fire from the bottom up could be decreased significantly, whereby the heat conducted to the pot handle could be lessened correspondingly. Moreover, the increased thickness of the proximal end ensures that the proximal end could be firm enough. Though, of course, a high-intensity material which fits the proximal end of the pot handle with small width and thickness, may come true in the future.

The end surface of the first connecting portion 110 that contacts with the pot body is a curved surface. The radian of the curved surface is consistent with the radian of the outer surface of the pot body, such that the end surface is attached closely to the surface of the pot body. The two ends of the first connecting portion 110 are symmetrically provided with rivet holes 111 which are used to connect the pot body and the first connecting portion 110. In order to further reduce the heat conducted directly to the first connecting portion 110 from the pot body, at the edge of the end surface of the first connecting portion 110 that contacts with the pot body, bumps 112 protruding toward the pot body are disposed. The portion of the bump 112 that contacts with the pot body is attached closely to the pot body, such that the most area of the end surface of the first connecting portion 110 connected to the pot body would not contact directly with the pot body since an air layer presents between the end surface of the first connecting portion 110 and the pot body. The thickness of the air layer is equal to the thickness of the bump. Due to this air layer, the first connecting portion 110 is connected to the pot body through the bumps 112 only, whereby the heat conducting area decreases significantly. Therefore, the heat conducted to the proximal end from the pot body is reduced significantly thereby decreasing the temperature of the pot handle and realizing the scald-proof effect. If a plurality of discrete bumps are adopted to be in contact with the pot body, smoke, steam or other impurities tends to enter the air layer between the first connecting portion and the pot body or the gap between the bumps. They are apt to be accumulated there and it is difficult to clean them up, which would affect the service life of the proximal end. Therefore, the bumps 112 are preferably arranged in a circle along the edge of the end surface of the first connecting portion 110 that is connected to the pot body.

In the vertical section of the pot handle, the second connecting portion 120 are arranged inclining upward relative to the first connecting portion 110, the second connecting portion 120 and the handle body 200 are connected to each other and form an integral arc. The pot handle is designed to incline upward and thus could be kept far away from fire, thereby further reducing the heat transfer and accelerate the heat dissipation. Moreover, the arc-shaped joint could improve the comfort for the users when they are holding the handle body.

The top end surface of the distal end 300 is provided with an extending portion 310. The extending portion 310 is provided with an opening 320 for hanging the pot handle.

The maximum width of the handle body 200 is less than the maximum width of the first connecting portion 110 and greater than the maximum width of the distal end 300. The shell of the handle body 200, the proximal end 100 and the distal end 300 are all made of stainless steel. The handle body 200 is connected to the proximal end 100 and the distal end 300 through being inserted into them, and the joints are fixed.

During the cooking process, only a small area of the first connection portion is in contact with the pot body due to the continuous and closed bump, thereby reducing the heat conducted directly to the pot handle from the pot body. The heat from the pot body is conducted from the proximal end to the handle body, and then the heat is absorbed rapidly by the heat absorbing component accommodated within the cavity of the handle body. The space layer within the handle body serves to prevent the heat from being conducted from the heat absorbing component to the shell of the handle body, thereby decreasing the temperature of the shell of the handle body significantly. The width of the joint between the second connecting portion and the first connecting portion of the proximal end is reduced, such that the area of the proximal end that is in contact with the fire from bottom up is decreased further, and thus the heat of the fire that is conducted directly to the pot handle is accordingly lessened. The pot handle is made of stainless steel, which could further decrease the temperature of the pot handle due to the low heat conductivity of the stainless steel. Furthermore, this configuration of the pot handle could realize a good heat isolation effect with a sufficient overall strength.

1. A scald-proof pot handle, characterized in that it comprises a proximal end, a handle body and a distal end which are connected in order, wherein a heat absorbing component is disposed within the handle body and extends along the same direction of the handle body, the heat absorbing component is connected and fixed to one end of the handle body, and an air layer is formed between the heat absorbing component and the handle body.

2. The scald-proof pot handle according to claim 1, characterized in that: the proximal end comprises a first connecting portion and a second connecting portion, the first connecting portion is connected to the pot body, the second connecting portion is connected to the handle body, and the ratio k of the minimum width of the joint between the first connecting portion and the second connecting portion to the maximum of the width of the handle body ranges from 0.1 to 0.6.

3. The scald-proof pot handle according to claim 2, characterized in that: the end surface of the first connecting portion that contacts with the pot body is a curved surface, and the radian of the curved surface is consistent with the radian of the surface of the pot body.

4. The scald-proof pot handle according to claim 3, characterized in that: at the edge of the end surface of the first connecting portion that contacts with the pot body, bumps protruding toward the pot body are disposed, and the portion of the bump that is in contact with the pot body is attached closely to the pot body.

5. The scald-proof pot handle according to claim 4, characterized in that: the bumps are arranged in a circle along the edge of the end surface of the first connecting portion that is connected to the pot body.

6. The scald-proof pot handle according to claim 1, characterized in that: the proximal end, the handle body and the distal end are all made of stainless steel.

7. The scald-proof pot handle according to claim 2, characterized in that: two ends of the first connecting portion are symmetrically provided with rivet holes which are used to connect the pot body and the first connecting portion.

8. The scald-proof pot handle according to claim 2, characterized in that: the maximum width of the handle body is less than the maximum width of the first connecting portion and greater than the maximum width of the distal end.

9. The scald-proof pot handle according to claim 1, characterized in that: a top end surface of the distal end is provided with an extending portion, and the extending portion is provided with an opening for hanging the pot handle.

10. The scald-proof pot handle according to claim 1, characterized in that: the handle body is connected to the proximal end and the distal end through being inserted into them, and the joints are fixed.
